(19) United States
(12) Patent Application Publication
(10) Pub. No.: US 2024/0256348 A1
(43) Pub. Date: Aug. 1, 2024

(54) GRAPHICAL MEMORY SHARING

(71) Applicant: Netflix, Inc., Los Gatos, CA (US)

(72) Inventors: Gregoire Pean, San Francisco, CA (US); Nitin Gupta, Morgan Hill, CA (US); Kyle Weicht, Victor, NY (US); Jonathan Newberry, Hayward, CA (US)

(21) Appl. No.: 18/174,438

(22) Filed: Feb. 24, 2023

Related U.S. Application Data
(60) Provisional application No. 63/481,751, filed on Jan. 26, 2023.

(51) Int. Cl. G06F 9/50; G06F 9/54

(52) U.S. Cl. CPC G06F 9/5033; G06F 9/5038; G06F 9/541

(57) ABSTRACT

The disclosed computer-implemented method includes instantiating a memory management process that is configured to communicate with graphics processing hardware components to control usage of shared memory by multiple different application instances. The memory management process also receives a request from an application instance indicating that content associated with a specific resource implemented by the application instance is to be stored in the shared memory, determines that the content identified in the request has been previously stored at a specified location in the shared memory, identifies a time span during which the identified content stored in the shared memory will be immutable, and instructs the requesting application instance to access the identified content from the specified location in shared memory during the identified time span. Various other methods, systems, and computer-readable media are also disclosed.

### CROSS REFERENCE

This application claims the benefit of U.S. Provisional Application No. 63/481,751 filed Jan. 26, 2023, the disclosure of which is incorporated, in its entirety, by this reference.

### BACKGROUND

Cloud gaming is becoming increasingly popular. In cloud gaming scenarios, video game data (including graphics) are largely rendered on remote servers and then transmitted to gaming clients where those data are decoded and displayed on an electronic device. When processing this video game data, the remote servers receive requests from video game applications to store data in easily accessible memory locations, typically referred to as random-access memory (RAM) or video RAM (VRAM). Because VRAM is very fast, it is also expensive and thus limited in quantity. When running many thousands or even millions of concurrent video game sessions on cloud servers, access to this VRAM becomes highly contested. Moreover, simply reusing memory that might overlap between applications becomes problematic when accounting for highly specialized graphics processing units (GPUs) that asynchronously access content at virtually any time and without notice.

### SUMMARY

As will be described in greater detail below, the present disclosure describes methods and systems for sharing memory among multiple application instances. In one example, a computer-implemented method includes instantiating a memory management process that is configured to communicate with one or more graphics processing hardware components to control usage of shared memory by multiple different application instances. These application instances may belong to a single software application or to multiple different applications or processes. The memory management process: receives a request from at least one the application instances indicating that content associated with a specific resource implemented by the application instance is to be stored in the shared memory, determines that the content identified in the request has been previously stored at a specified location in the shared memory, identifies a time span during which the identified content stored in the shared memory will be immutable, and instructs the requesting application instance to access the identified content from the specified location in shared memory during the identified time span.

In some embodiments, the memory management process instructs the requesting application instance to access the identified content from the specified location in shared memory during the identified time span instead of storing the content associated with the specified resource in the memory.

In some examples, the identified content stored in the shared memory is monitored by the memory management process. In some cases, the memory management process is embedded in an application process package file associated with the application instance that sent the request.

In some embodiments, the memory management process determines whether the specific resource is already being managed by the memory management process using one or more resource identifiers or resource characteristics obtained from the application process package file. In some cases, the application process package file comprises a game engine for a video game. In other cases, the memory management process is dynamically loaded along with the application instance that sent the request. In some examples, the memory management process is dynamically loaded using a Vulkan layer that allows dynamic interception of graphics application programming interface (API) calls.

In some examples, the memory management process determines whether the specific resource is already being managed by the memory management process using one or more resource identifiers or resource characteristics obtained from at least one intercepted API call. In some cases, at least one of the resource identifiers obtained from the intercepted API call is a universally unique identifier (UUID). In some cases, the intercepted API call increments a reference count and returns a shared file descriptor that points to a memory backing that was previously allocated for the resource. In some embodiments, the application instance uses the shared file descriptor when accessing the specific resource.

In addition, a corresponding system includes at least one physical processor, and physical memory comprising computer-executable instructions that, when executed by the physical processor, cause the physical processor to: instantiate a memory management process that is configured to communicate with one or more graphics processing hardware components to control usage of shared memory by multiple different application instances. The memory management process: receives a request from at least one the application instances indicating that content associated with a specific resource implemented by the application instance is to be stored in the shared memory, determines that the content identified in the request has been previously stored at a specified location in the shared memory, identifies a time span during which the identified content stored in the shared memory will be immutable, and instructs the requesting application instance to access the identified content from the specified location in shared memory during the identified time span.

In some embodiments, the memory management process preloads one or more resources for the application instance that sent the request. In some cases, the memory management process preserves the specified resource in the shared memory for at least a specified amount of time after determining that the specified resource is no longer being used by the multiple application instances. In some examples, the specified resource is preserved in the shared memory for the specified amount of time based on a determined amount of churn that is related to the specified resource.

In some cases, content identified as being mutable is shared by the memory management process in a pool among the multiple different application instances. In some embodiments, the content identified as being mutable is associated with a fence synchronization object that is used to track when asynchronous tasks performed using the content are completed. The fence synchronization objects are configured to protect against concurrent or non-exclusive use of the mutable content. In some examples, the memory management process redistributes the content identified as being mutable to the pool upon completion of the asynchronous tasks.

In some examples, the above-described method is encoded as computer-readable instructions on a computer-readable medium. For example, the computer-readable medium may include one or more computer-executable instructions that, when executed by at least one processor of a computing device, cause the computing device to instantiate a memory management process that is configured to communicate with one or more graphics processing hardware components to control usage of shared memory by multiple different application instances. The memory management process: receives a request from at least one the application instances indicating that content associated with a specific resource implemented by the application instance is to be stored in the shared memory, determines that the content identified in the request has been previously stored at a specified location in the shared memory, identifies a time span during which the identified content stored in the shared memory will be immutable, and instructs the requesting application instance to access the identified content from the specified location in shared memory during the identified time span.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates a computing environment in which the embodiments herein are designed to operate.

FIG. 2 is a flow diagram of an exemplary method for sharing memory among multiple application instances.

FIG. 3 illustrates an alternative computing environment in which the embodiments herein are designed to operate.

FIGS. 4A and 4B illustrate embodiments in which different memory management processes are loaded and implemented.

FIG. 5 illustrates an embodiment in which different application instances share a pool of mutable content.

FIG. 6 is a block diagram of an exemplary content distribution ecosystem.

FIG. 7 is a block diagram of an exemplary distribution infrastructure within the content distribution ecosystem shown in FIG. 6.

FIG. 8 is a block diagram of an exemplary content player within the content distribution ecosystem shown in FIG. 6.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to methods and systems for sharing video memory (i.e., graphics processing unit (GPU) memory) among multiple application instances. As noted above, applications, such as video games, are often hosted remotely on cloud computing systems. These cloud computing systems are capable of running many thousands or millions of concurrent gaming instances. In some cases, each of these application instances runs separately and uses its own collection of resources or content. In other cases, some of these application instances use resources that may be identical to the resources used by another instance. For example, if multiple video game instances are running concurrently, at least some of those video game instances will likely use the same textures, the same shaders, the same buffers, or other similar types of content. This type of static content has the potential to be shared among the various application instances.

Such sharing, however, is not trivial, as current graphics processing units (GPUs) are designed to run asynchronously, accessing different assets at different times and without notice. GPU devices typically operate using their own segregated hardware. For instance, each physical GPU device has its own processor (or set of processing cores) and an allocation of video random-access memory (VRAM). This VRAM operates very quickly and with very high throughput. As a result, the GPU device will have less VRAM than a general processing computer would have with its corresponding traditional RAM. When running multiple game instances on a single GPU, VRAM thus becomes a contested resource and a primary bottleneck as the number of concurrent video game sessions increases.

To mitigate these issues, the embodiments herein aim to share VRAM memory regions, despite the asynchronous nature of the GPU. When running similar or identical copies of a particular video game (or other application), the systems herein significantly reduce VRAM requirements by re-using, or de-duplicating identical regions of memory across those instances. These systems establish a memory management process that communicates with GPU hardware components and APIs directly to identify which portions of content are immutable (unchangeable) and which portions of content are (or would be) duplicative. For those portions of content that are immutable and duplicative, the memory management process can perform deduplication to free up the corresponding memory regions. For those portions of content that would be duplicated if copied into memory by a video game instance, the memory management process determines which content would be duplicated and, instead of loading that content into memory, reuses the content already stored in memory.

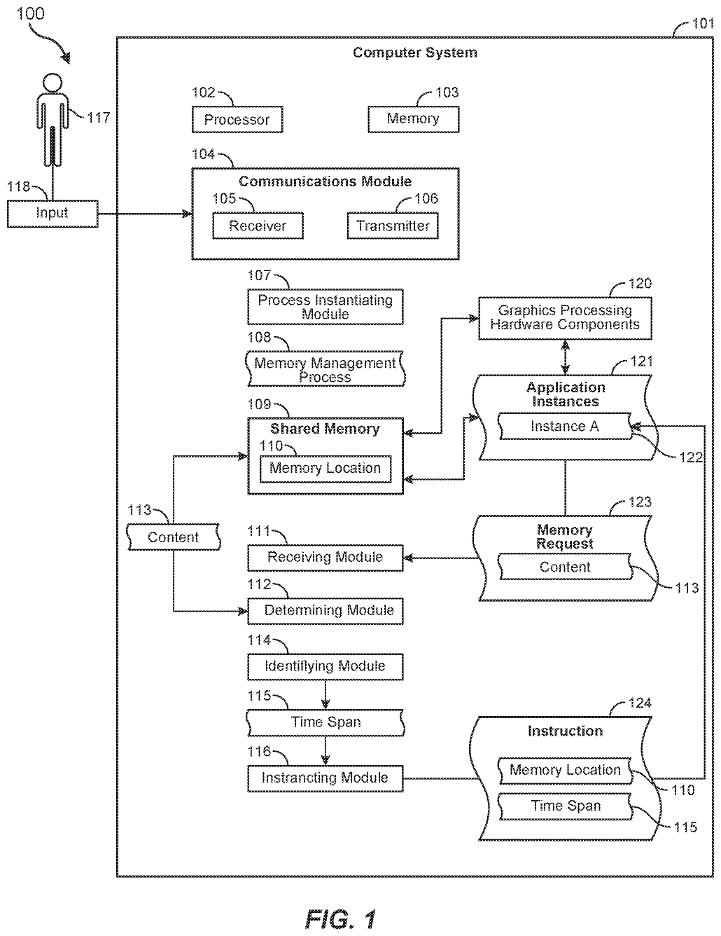

The embodiments herein also provide methods and systems for pooling VRAM resources for common processes, even when the data in memory is mutable. For memory regions that are not identical across game instances, but for which content is only temporarily or transiently needed to render a video frame of the game, the embodiments herein reallocate those memory regions in an exclusive, time-shared (“pooled”) manner across video game instances. The systems herein then provide virtual fencing objects for those pooled resources. The virtual fencing objects allow those resources to be used by multiple application instances within a virtual fence for a limited time. Once the virtual fence has been removed, those resources are unloaded from VRAM. These embodiments will be described in greater detail below with regard to FIGS. 1-8.

FIG. 1 illustrates a computing environment 100 that includes a computer system 101. The computer system 101 includes software modules, embedded hardware components such as processors, or includes a combination of hardware and software. The computer system 101 includes substantially any type of computing system including a local computing system or a distributed (e.g., cloud) computing system. In some cases, the computer system 101 includes at least one processor 102 and at least some system memory 103. The computer system 101 includes program modules for performing a variety of different functions. The program modules are hardware-based, software-based, or include a combination of hardware and software. Each program module uses computing hardware and/or software to perform specified functions, including those described herein below.

The computer system 101 includes a communications module 104 that is configured to communicate with other computer systems. The communications module 104 includes any wired or wireless communication means that can receive and/or transmit data to or from other computer systems. These communication means include hardware interfaces including Ethernet adapters, WIFI adapters, hardware radios including, for example, a hardware-based receiver 105, a hardware-based transmitter 106, or a combined hardware-based transceiver capable of both receiving and transmitting data. The radios are cellular radios, Bluetooth radios, global positioning system (GPS) radios, or other types of radios. The communications module 104 is configured to interact with databases, mobile computing devices (such as mobile phones or tablets), embedded or other types of computing systems.

The computer system 101 also includes a process instantiating module 107. The process instantiating module 107 executes, runs, loads, or otherwise operates a memory management process 108. The memory management process 108 (alternatively referred to as a GPU memory server (GMS) herein) is a daemon process or other software process that communicates with graphics processing hardware components 120 and manages shared memory 109 (among other potential operations). The graphics processing hardware components 120 include graphics processing units, VRAM or other type of random-access memory, data storage (e.g., solid state or disc-based hard drives, flash memory, etc.), hardware controllers, serial buses, or other hardware components. Additionally or alternatively, the memory management process 108 may communicate with operating systems, kernels, firmware modules, or other software systems. The memory management process 108 communicates with these hardware and/or software components, monitors API calls, memory requests, or other inter-component communications, and determines when memory can be shared.

In the embodiments herein, content in the shared memory 109 can be shared when memory locations or memory regions are identical, when the content in those regions is temporally consistent (i.e., immutable), and when the memory locations' existence overlaps in time. The memory management process 108 includes or has access to different hardware or software modules to make these determinations. For instance, in some cases, the receiving module 111 receives a memory request 123 from an application instance 122, which may be one of many different application instances 121. Each of these application instances may be part of a different user's video game session. While the application instances 121 are frequently referred to herein in conjunction with video games, it will be understood that these embodiments may be used with substantially any type of software application and are not limited to video games or graphics processing hardware implementations.

The memory request 123 sent by the application instance 122 includes an indication that specific content (e.g., content 113) is to be stored in the shared memory 109 (e.g., VRAM). The content may include any type of digital data that is to be at least temporarily stored in shared memory. This includes static assets such as textures, mesh vertex buffers, shader programs, or other types of static content. Additionally or alternatively, the content 113 may include changeable assets such as collectable items, skins, graphical user interface (GUI) data, or other changeable content that is to be stored in the shared memory 109.

Upon receiving this memory request 123, the determining module 112 determines whether the content 113 is already stored in the shared memory 109. The identifying module 114 determines whether the content 113 is (or will become) mutable over time and, if so, identifies a time span 115 during which the content is immutable. During that time span 115 in which the content 113 is immutable and is identical to the previously stored content (e.g., at memory location 110), the memory management process 108 will determine that the previously stored content is shareable or reusable and will cause the instructing module 116 to send an instruction 124 to the application instance 122 indicating the memory location 110 at which the previously stored content exists. The instruction 124 also indicates a time span 115 during which that data will be immutable. The application instance 122 then uses the previously stored content 113 at memory location 110 during execution.

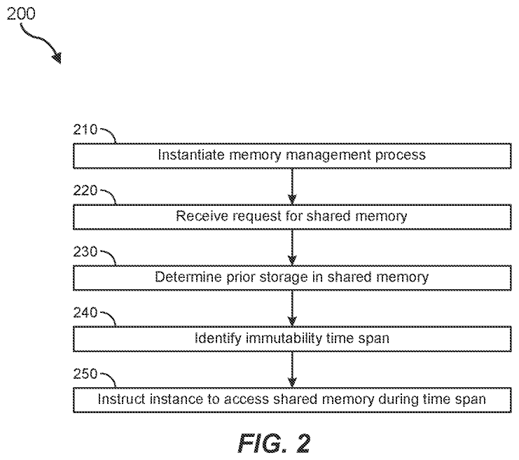

In this manner, the memory management process 108 can avoid storing the requested content in shared memory (per the request 123) and, instead, points the application instance 122 to the previously stored data. This saves space in the shared memory 109 for other content and (at least partially) removes the previous bottleneck of having to store each portion of application content in VRAM due to the asynchronous nature of the GPU. In some cases, this process is adapted or changed based on input 118 from a user 117 (or from many users across multiple application instances). For instance, as will be discussed further below, some data may be kept in memory even after an application instance stops using the data due to frequent requests for that data caused by the input 118 of the user 117, whether directly or indirectly. These embodiments will be explained further below with regard to method 200 of FIG. 2.

FIG. 2 is a flow diagram of an exemplary computer-implemented method 200 for sharing video memory. The steps shown in FIG. 2 may be performed by any suitable computer-executable code and/or computing system, including the system illustrated in FIG. 1. In one example, each of the steps shown in FIG. 2 may represent an algorithm whose structure includes and/or is represented by multiple sub-steps, examples of which will be provided in greater detail below.

As illustrated in FIG. 2, at step 210 one or more of the systems described herein instantiates a memory management process that is configured to communicate with one or more graphics processing hardware components to control the usage of shared memory by multiple different application instances. At step 220, the memory management process receives a request from at least one of the application instances indicating that content associated with a specific resource implemented by the application instance is to be stored in the shared memory. At step 230, the memory management process determines that the content identified in the request has been previously stored at a specified location in the shared memory. At step 240, the memory management process identifies a time span during which the identified content stored in the shared memory will be immutable and, at step 250, instructs the requesting application instance to access the identified content from the specified location in shared memory during the identified time span.

Thus, at least in some embodiments, the process instantiating module 107 of computer system 101 of FIG. 1 is configured to communicate with graphics processing hardware components 120, including at least a portion of shared memory 109, to control the usage of the shared memory by multiple different application instances 121. The memory management process 108 receives requests from these application instances 121 to store content (i.e., digital data) in the shared memory 109. Storing the content 113 in the shared memory will make the content easier to access and quicker to load for use in the application instance.

Instead of simply storing the content 113 in the shared memory 109 based on the application instance's memory request 123, the memory management process 108 determines whether existing stored content could be reused. Because the graphics processing hardware components 120 (which may be the same as or different than the processor 102 and memory 103 of computer system 101) access the shared memory 109 in an unpredictable, asynchronous manner, various other steps are performed to ensure that the content already stored in the shared memory 109 can be reused. Or, in cases where duplicate copies already exist in the shared memory, at least one of the copies can be deduplicated or removed from the shared memory.

Accordingly, the determining module 112 determines whether the content 113 identified in the memory request 123 is already loaded in the shared memory 109. If so, the identifying module 114 determines a time span 115 or time frame in which the content will remain immutable in the shared memory 109. Upon determining this time frame, the instructing module 116 then generates and sends an instruction 124 to the application instance (e.g., instance 122) indicating the memory location 110 of the previously stored (identical) data, and the time span 115 during which the data will remain immutable. During this time span, however brief, the application instance 122 can then access this content 113, and the memory management process 108 can avoid storing the requested content 113 in the shared memory 109.

As noted above, in order to share identical memory regions across video game (or other application) instances, the memory management process 108 will determine: 1) which memory regions are identical (i.e., which memory regions include identical digital data), 2) whether these memory regions are temporally consistent (i.e., whether their content is immutable or is mutable over time), and 3) whether the existence of the identical memory regions overlap in time.

The embodiments described herein are configured to obtain that information from the GPU's video game engine. In traditional graphics rendering scenarios, GPU drivers associated with the GPU or even the GPU itself have no direct knowledge of this information. Instead of determining which memory regions are identical, whether the data is mutable, or whether the memory requests overlap in time by looking at abstract memory regions or memory pages, the embodiments herein are configured to access the game's graphical resources directly. In this context, a “resource” may refer to a texture (an image), a generic buffer, or a specialized resource such as a shader program. Such resources are typically backed by one or more VRAM memory regions. Some memory regions may back several different resources. Moreover, some resources are read-only, while others can be written to.

In order to ensure the temporal consistency of resources and maximize content sharing within the shared memory 109, as well as minimize the complexity of memory sharing, at least one of the embodiments described herein identifies resources that are read-only read and are not written to. This is especially applicable to video games, since video games tend to upload large amounts of immutable resources to VRAM, such as static assets, textures, mesh vertex buffers, shader programs, etc.

Further benefits of deduplication or reusing memory content is that the memory management process can reduce video game load times, as well as reduce PCI-e bus utilization since a game resource is already resident in VRAM. Indeed, when a video game resource is already loaded into VRAM, there is no need to re-upload that resource to VRAM when a new game instance starts or when a different game instance needs access to that resource. Still further, delays or costs associated with uploading a resource in VRAM, such as the need to re-arrange or optimize its layout in VRAM (e.g., tiled storage model for textures) will be avoided.

In some embodiments, the memory management process 108 may be a daemon process referred to herein as a GPU Memory Server (GMS). The GMS daemon may “fully own” or may be fully responsible for resource management among the shared memory 109 and the graphics processing hardware components 120. The GMS may be a centralized process that all (or at least some subset of) game processes will communicate with. These communications, at least in some cases, occur over inter-process communication (IPC). Such IPC may include communication via operating system sockets, for example, via a GPU Memory Client (GMC) library that acts as an aid in communication. The GMC can either be embedded in one of the video game process package files or binary files or can be dynamically loaded using a loading mechanism such as Vulkan layers that allow dynamic interception of graphics API calls. Both the GMS and the video game process ultimately talk to the GPU vendor's installable client driver (ICD), which implements the graphics API calls. In this manner, the embodiments herein are GPU-vendor agnostic and, as such, may work with any GPU or processor provider.

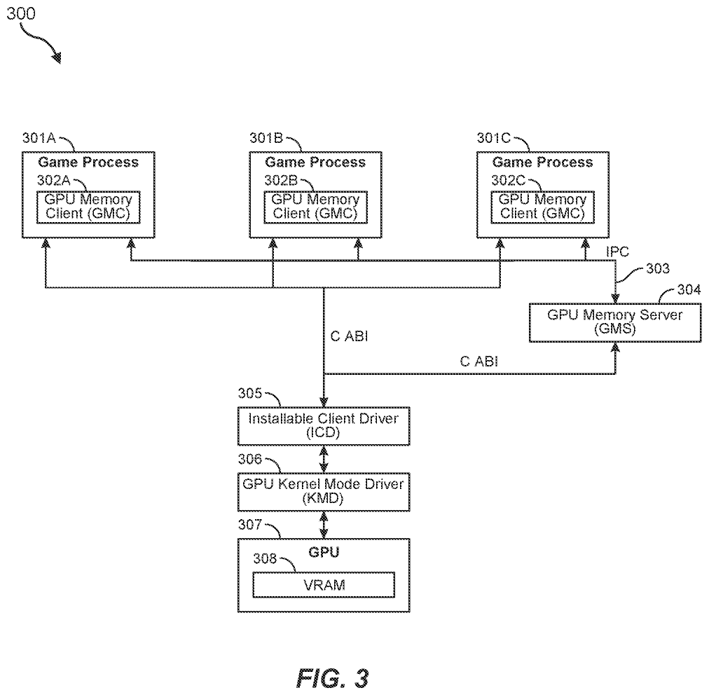

FIG. 3 illustrates an embodiment 300 in which the GMS 304 intermediates between a GPU 307 and different game processes 301A, 301B, and 301C. Each game process 301A-301C may be associated with a gaming session or other application instance. Each game process 301A-301C includes its own instance of a GPU memory client (302A-302C). As noted above, the GPU memory client communicates with the GMS 304, and the GMS 304 communicates with the GPU 307 (and its associated VRAM 308) through an installable client driver (ICD 305) and a GPU kernel mode driver 306. By intercepting or otherwise accessing memory calls from the game processes 301A-301C and/or from the ICD 305, the GMS 304 becomes aware of which content is loaded in VRAM 308 and further determines how long that content will remain immutable. During this time in which the content is known to be immutable, the memory location of that content is shared among the various game processes 301A-301C and is reused.

Still further, requests from the game processes 301A-301C to store the known, immutable content in VRAM 308 are headed off and, instead, filled using the known, previously stored content. Because the GMS 304 is in substantially constant communication with the GPU 307, the GMS remains up to date on which content is stored in the VRAM 308, where the content is stored, and how long each portion of content is immutable. As such, the stored content may be safely shared, despite the asynchronous accesses by the GPU 307.

At least in some embodiments, the GMC (and therefore the GMS) provides API endpoints to check whether a portion of content or resource is already managed by the GMS. In some cases, the content or resource has a universally unique identifier (UUID) associated with it. The GMS can then use that UUID to determine resource characteristics and other information obtained from the game processes 301A-301C. The UUID and other information is determined by either intercepting graphics API calls or via explicit integration with the underlying game engine that runs the various game processes. In some examples, these API calls optionally increment a reference count and return a shared file descriptor or handle that points to the memory backing already allocated for the resource. The game processes 301A-301C can then directly use that previously allocated memory in their operations.

In some cases, the game processes 301A-301C and/or the GPU memory clients 302A-302C are configured to add new resources to memory that are to be tracked by the GMS. In such cases, the game processes or GPU memory clients provide the resource UUID and resource characteristics obtained from the game engine. The GMS will then return a shared file descriptor or handle that points to the memory backing allocated for the resource, which the game can directly use in return. This memory backing is owned by the GMS 304. The game processes then use a secondary API call to signal when the resource has been fully set up or when the memory backing has been filled with data. This, then, signals that other GPU memory clients can start referencing the backing as well.

In cases where a given resource is no longer being used, the game process and/or GPU memory client will notify the GMS 304 using an end-of-process notification indicating that specific resources are no longer needed. This process will then decrement the memory backing's reference count. This, in turn, allows the GMS 304 to decide when to evict the memory backing from its cache or collection of resident resources. In some cases, this happens later than when the last reference to the resource is decremented. For instance, the GMS 304 may determine that certain resources are in high demand and are repeatedly used by different game processes. In such cases, the GMS determines to keep the resource stored in VRAM, even if that resource is not currently being used. In this instance, the GMS 304 overrides the end-of-process notification and maintains the resource in VRAM 308. Indirect end-of-use notifications are also supported. For example, in cases where a game process terminates unexpectedly, by tracking the IPC connection state, the GMS 304 is able to automatically decrement reference counts, indicating that the resource is ok to unload from memory.

While the embodiments described above are often implemented in conjunction with immutable and/or read-only resources, the embodiments herein also contemplate the use of mutable resources, including resources whose size and nature is common across instances, via temporal sharing. Indeed, in a multi-tenant scenario, where many video game (or other application) instances are running simultaneously against the same GPU 307, some resources such as frame buffers used as render targets have content which does not need to persist frame-over-frame, and yet which remain the same size. Moreover, games utilize those memory backings for a time period that is smaller than the overall target frame interval. The games and applications described herein often render faster or are done rendering a frame after a duration that is smaller than the target frame interval. This, then, creates an opportunity for using the same resource or at least its memory backing from one instance's frame rendering to another instance's frame rendering.

For memory regions that are not identical across game processes, but for which content is only temporarily or transiently needed to render a game frame, and which memory is otherwise not continuously needed or used, the embodiments herein reallocate those memory regions in an exclusive, time-shared manner (referred to as “pooled” herein) across game processes. By using a separate, shared process to pool and track those resources so that they can be reused in time, the embodiments herein provide lower memory utilization, less memory fragmentation over time, and faster resource allocations.

Furthermore, pooling and ownership of resources by another common process presents a further benefit of making it possible for game processes to produce frame buffers that can be maintained in memory for a longer period of time throughout the rest of the system and for other purposes than game rendering. This frees up the video game processes from having to manage that persistence, and it removes the need to copy those resources as well (which, in some cases, can be a very CPU- and memory-intensive process).

For instance, in one example, when a game process has finished rendering, the render target frame buffer can continue to live throughout the encoding pipeline until the buffer is no longer needed. Without creating a waiting point in the game rendering logic (e.g., swap chain image acquisition), when the game process needs to use the same frame buffer again, the encoding process can itself return the frame buffer resource to a common pool of resources. Once the game process is done with the frame buffer, the game process no longer needs to synchronize itself or work around that delayed use. In other words, the embodiments herein are designed to abstract out the relationship between the backend video game processes and the client-side encoding process in a cloud gaming scenario. Moreover, these embodiments better utilize memory at the same time because a resource that is no longer needed can instantly be recycled and reused through the pooling process.

At least in some cases, the implementation implements the same topology as is used in deduplication, generally shown in FIG. 3. The GMS 304 is used to own, pool resources, and distribute the resources in an exclusive fashion (i.e., each resource has a single writer at any given time). The respective GPU memory clients 302A-302C act as an interface library or intermediary with the GMS 304, where communications occur over IPC. For resources that are writable, the embodiments herein ensure that asynchronous tasks performed by the GPU against the writable resources are indeed fully completed before a resource is redistributed for reuse.

To accomplish this, each resource is associated with a semaphore or fence synchronization object. In different scenarios with different vendors' GPUs, the fence synchronization object may have different names or characteristics. The GMS (or other pooling mechanism) is configured to wait on that fence synchronization object before redistributing a given resource. Additionally or alternatively, the GMS 304 may favor resources that had their associated fence signaled and for which work was completed before redistribution. This, in turn, minimizes propagation delays between processes or across different uses of the resource. Client processes (e.g., 301A-301C) signal when they have completed work through associated fence objects. In this manner, the GMS 304 and other components are implemented to reuse even mutable resources among different game processes.

For those resources that are immutable and/or are read-only, the memory management process (e.g., the GMS 304) instructs the requesting application instances (e.g., game processes 301A-301C) to access requested content from a specific location in shared memory. The instruction may also indicate a time frame or time span during which the content will be immutable. The game process then accesses the previously stored content, and the GMS 304 can avoid storing the content associated with that resource in memory. In such embodiments, the GMS 304 is said to own that resource, meaning that it will manage that content and monitor and control its usage among the various game processes (or other application instances).

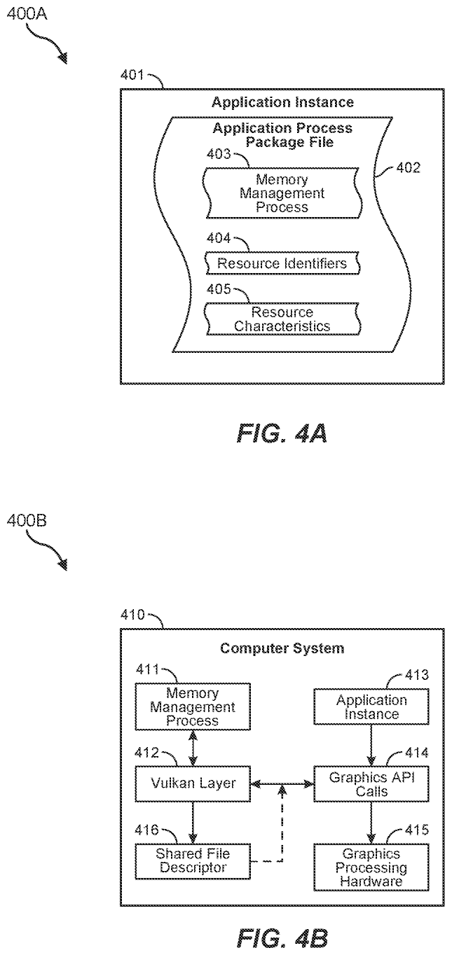

FIG. 4A illustrates an embodiment 400A in which a memory management process is embedded in an application process package file associated with the application instance that sent the request. For instance, in some cases, the memory management process 403 (which may be similar to or the same as GMS 304 of FIG. 3) is embedded in an application process package file 402 that is part of an application instance 401. As such, the memory management process 403 is automatically loaded as part of the application instance 401. In such cases, the memory management process 403 is capable of determining whether a specific resource is being managed by the memory management process using one or more resource identifiers 404 or resource characteristics 405 obtained from the application process package file 402.

The memory management process 403, in such examples, is an embedded part of the application instance 401. In cases where the application instance 401 is a video game instance, the application process package file(s) may be part of a game engine or may be used by a game engine when running a video game instance. The application process package files may provide resource identifiers or resource characteristics that come through the video game process at runtime from the video game package files or from other application resource files. The memory management process 403 has low-level access to each memory call or memory operation conducted by the video game instance. Using UUIDs and resource characteristics, such as resource size, resource file type, read-only or write-only status, mutable or immutable status, or other characteristics, the memory management process 403 can determine when and how often a resource is used and whether that resource can be shared among the various application instances.

In other examples, the memory management process is dynamically loaded along with the application instance that sent the request. For instance, as shown in embodiment 400B of FIG. 4B, a memory management process 411 is dynamically loaded using a Vulkan layer 412 that allows dynamic interception of graphics API calls 414. The memory management process 411 determines whether a specific resource is already being managed by the memory management process 411 using various resource identifiers or resource characteristics obtained from at least one intercepted API call. As noted above, the resource identifiers obtained from the intercepted API call may be UUIDs. In some cases, the intercepted graphics API call 414 increments a reference count and returns a shared file descriptor 416 that points to a memory backing that was previously allocated for the resource. The application instance 413 then uses the shared file descriptor 416 when accessing the specific resource stored in memory in the graphics processing hardware 415 of the underlying computer system 410.

In some embodiments, the memory management process 411 assumes full ownership or full management control over interoperations between application instances 413 and graphics processing hardware 415. As part of this management, the memory management process 411 preloads various resources for application instances as they send memory storage requests. For instance, the memory management process 411 that is dynamically loaded using a Vulkan layer 412 may intercept graphics API calls 414 and may determine that certain resources are being used or will likely be used in the future. In such cases, some of the identified resources are preloaded into memory (e.g., VRAM) before the resources are actually requested by the application instances. This reduces access time once the application instances eventually request that the resource be loaded into memory.

Still further, in some cases, the memory management process 411 preserves specific resources in the shared memory for a specified amount of time after determining that the specified resource is no longer being used by the multiple application instances. Thus, even if a resource is no longer being used by an application instance 413, the memory management process 411 may determine that the resource is to be maintained in memory. In some cases, the memory management process 411 looks at churn associated with the resource. If the resource is continually loaded and unloaded from memory (i.e., “churn”), the memory management process 411 will determine that because the churn level is high for that resource, it will be maintained in memory, even if it is not being currently used by an application instance. In some cases, a specific resource is preserved in shared memory for an amount of time that is based on or is proportional to a determined amount of churn related to that specific resource.

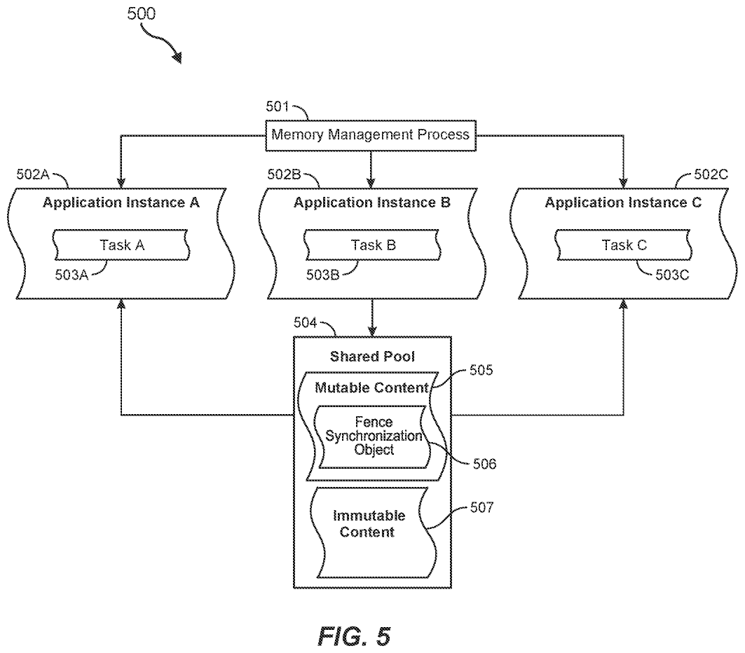

FIG. 5 illustrates an embodiment 500 in which a memory management process 501 identifies certain content as being mutable over time. This mutable content 505 is placed in a shared pool 504 where other application instances (e.g., 502A-502C) have access to that content (or other temporary content). The memory management process 501 shares the content identified as being mutable by using fence synchronization objects 506. A fence synchronization object 506 is used to determine when asynchronous tasks (e.g., 503A-503C) performed using the content are completed. In this manner, the memory management process 501 remains up to date and aware of which asynchronous tasks have been completed relative to a portion of mutable content. While the content is being used to perform the asynchronous tasks 503A-503C, the content is removed from the shared pool 504 and, when the content is done being used, the memory management process 501 returns the mutable content 505 to the shared pool 504 by changing the state of the fence synchronization object 506. In addition to the mutable content 505, the shared pool 504 may also include immutable content 507. This immutable content may be shared among the various application instances 502A-502C along with or as an alternative to the mutable content 505.

Whether the content is mutable or immutable, at least some of the embodiments herein may add copy on write protections to the content. The copy on write protections may ensure that if an application instance writes to a given file or resource, a separate copy of that resource will be made to ensure that the changes are saved and that the initial version is maintained. Then, even if a resource or some memory location is misidentified as being immutable, because the resources are marked as “copy on write,” the resource will be maintained in its original form. And, before any changes are applied, a separate (private) copy of the resource will be made. This ensures that data integrity is preserved across different application instances.

In addition to the computer-implemented method described above, a corresponding system is also described. The system includes at least one physical processor, and physical memory comprising computer-executable instructions that, when executed by the physical processor, cause the physical processor to: instantiate a memory management process that is configured to communicate with one or more graphics processing hardware components to control usage of shared memory by multiple different application instances, wherein the memory management process: receives a request from at least one the application instances indicating that content associated with a specific resource implemented by the application instance is to be stored in the shared memory, determines that the content identified in the request has been previously stored at a specified location in the shared memory, identifies a time span during which the identified content stored in the shared memory will be immutable, and instructs the requesting application instance to access the identified content from the specified location in shared memory during the identified time span.

Still further, a non-transitory computer-readable medium is provided that includes one or more computer-executable instructions that, when executed by at least one processor of a computing device, cause the computing device to: instantiate a memory management process that is configured to communicate with one or more graphics processing hardware components to control usage of shared memory by multiple different application instances, wherein the memory management process: receives a request from at least one the application instances indicating that content associated with a specific resource implemented by the application instance is to be stored in the shared memory, determines that the content identified in the request has been previously stored at a specified location in the shared memory, identifies a time span during which the identified content stored in the shared memory will be immutable, and instructs the requesting application instance to access the identified content from the specified location in shared memory during the identified time span.

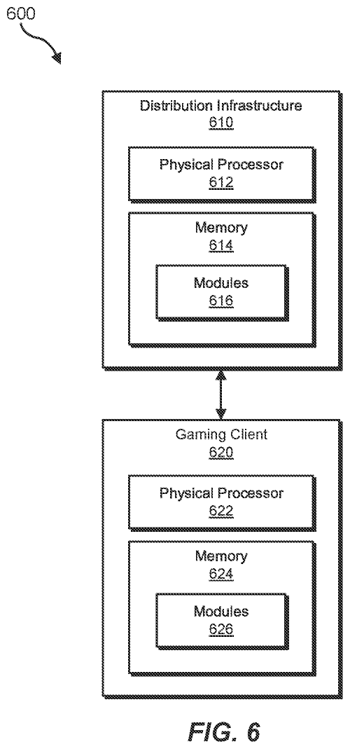

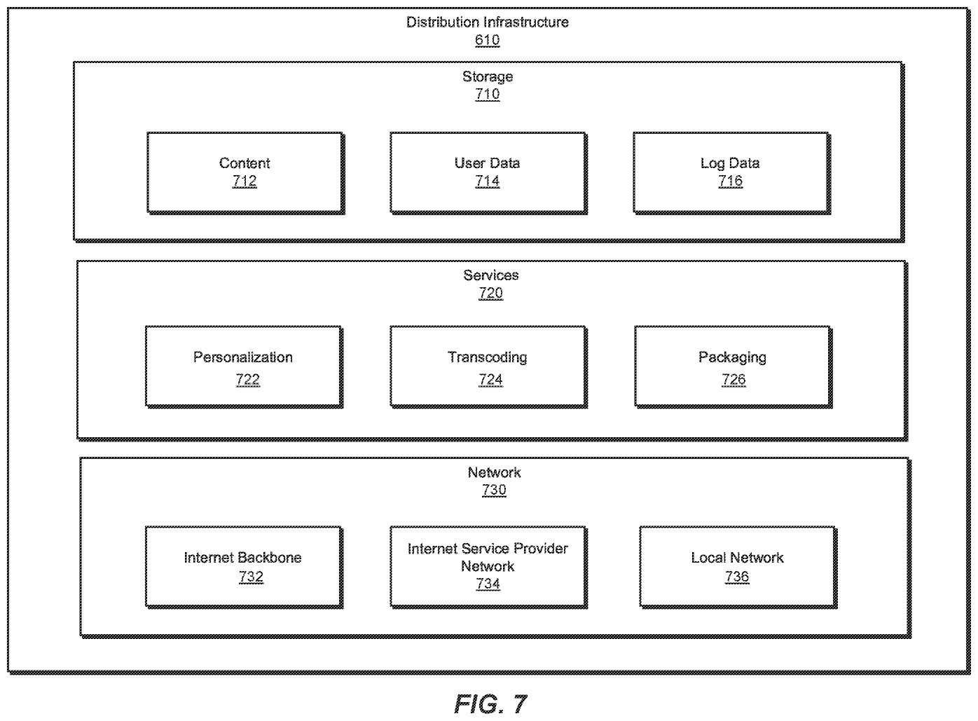

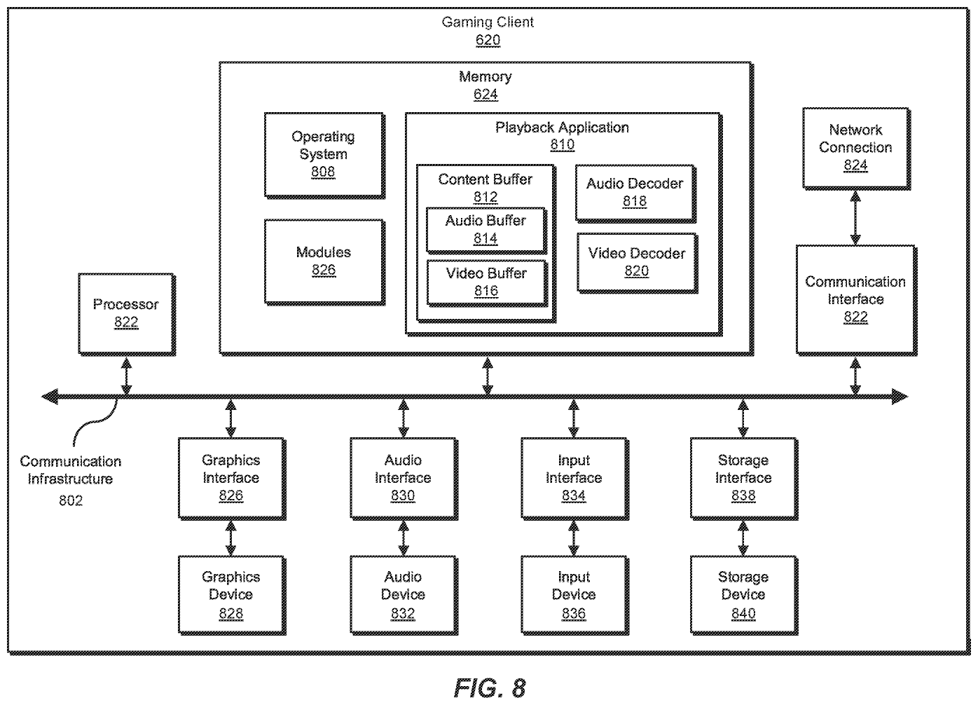

FIGS. 6-8 illustrate cloud gaming systems, infrastructure, and clients that may be implemented with the embodiments herein. For example, the following will provide, with reference to FIG. 6, detailed descriptions of exemplary ecosystems in which content is provisioned to end nodes and in which requests for content are steered to specific end nodes. The discussion corresponding to FIGS. 7 and 8 presents an overview of an exemplary distribution infrastructure and an exemplary content player used during playback sessions, respectively.

FIG. 6 is a block diagram of a content distribution ecosystem 600 that includes a distribution infrastructure 610 in communication with a gaming client 620, content player, or other software application designed to present rendered graphics to a user. In some embodiments, distribution infrastructure 610 is configured to encode data at a specific data rate and to transfer the encoded data to gaming client 620. Gaming client 620 is configured to receive the encoded data via distribution infrastructure 610 and to decode the data for playback to a user. The data provided by distribution infrastructure 610 includes, for example, audio, video, text, images, animations, interactive content, haptic data, virtual or augmented reality data, location data, gaming data, or any other type of data that is provided via streaming.

Distribution infrastructure 610 generally represents any services, hardware, software, or other infrastructure components configured to deliver content to end users. For example, distribution infrastructure 610 includes content aggregation systems, media transcoding and packaging services, network components, and/or a variety of other types of hardware and software. In some cases, distribution infrastructure 610 is implemented as a highly complex distribution system, a single media server or device, or anything in between. In some examples, regardless of size or complexity, distribution infrastructure 610 includes at least one physical processor 612 and at least one memory device 614. One or more modules 616 are stored or loaded into memory 614 to enable adaptive streaming, as discussed herein.

Gaming client 620 generally represents any type or form of device or system capable of playing audio, video, or other gaming content that has been provided over distribution infrastructure 610. Examples of gaming client 620 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 610, gaming client 620 includes a physical processor 622, memory 624, and one or more modules 626. Some or all of the adaptive streaming processes described herein is performed or enabled by modules 626, and in some examples, modules 616 of distribution infrastructure 610 coordinate with modules 626 of gaming client 620 to provide adaptive streaming of multimedia content.

In certain embodiments, one or more of modules 616 and/or 626 in FIG. 6 represent one or more software applications or programs that, when executed by a computing device, cause the computing device to perform one or more tasks. For example, and as will be described in greater detail below, one or more of modules 616 and 626 represent modules stored and configured to run on one or more general-purpose computing devices. One or more of modules 616 and 626 in FIG. 6 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 612 and 622 generally represent any type or form of hardware-implemented processing unit capable of interpreting and/or executing computer-readable instructions. In one example, physical processors 612 and 622 access and/or modify one or more of modules 616 and 626, respectively. Additionally or alternatively, physical processors 612 and 622 execute one or more of modules 616 and 626 to facilitate adaptive streaming of multimedia content. Examples of physical processors 612 and 622 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 614 and 624 generally represent any type or form of volatile or non-volatile storage device or medium capable of storing data and/or computer-readable instructions. In one example, memory 614 and/or 624 stores, loads, and/or maintains one or more of modules 616 and 626. Examples of memory 614 and/or 624 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 7 is a block diagram of exemplary components of content distribution infrastructure 610 according to certain embodiments. Distribution infrastructure 610 includes storage 710, services 720, and a network 730. Storage 710 generally represents any device, set of devices, and/or systems capable of storing content for delivery to end users. Storage 710 includes a central repository with devices capable of storing terabytes or petabytes of data and/or includes distributed storage systems (e.g., appliances that mirror or cache content at Internet interconnect locations to provide faster access to the mirrored content within certain regions). Storage 710 is also configured in any other suitable manner.

As shown, storage 710 may store a variety of different items including content 712, user data 714, and/or log data 716. Content 712 includes television shows, movies, video games, user-generated content, and/or any other suitable type or form of content. User data 714 includes personally identifiable information (PII), payment information, preference settings, language and accessibility settings, and/or any other information associated with a particular user or content player. Log data 716 includes viewing history information, network throughput information, and/or any other metrics associated with a user's connection to or interactions with distribution infrastructure 610.

Services 720 includes personalization services 722, transcoding services 724, and/or packaging services 726. Personalization services 722 personalize recommendations, content streams, and/or other aspects of a user's experience with distribution infrastructure 610. Encoding services 724 compress media at different bitrates which, as described in greater detail below, enable real-time switching between different encodings. Packaging services 726 package encoded video before deploying it to a delivery network, such as network 730, for streaming.

Network 730 generally represents any medium or architecture capable of facilitating communication or data transfer. Network 730 facilitates communication or data transfer using wireless and/or wired connections. Examples of network 730 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 7, network 730 includes an Internet backbone 732, an internet service provider 734, and/or a local network 736. As discussed in greater detail below, bandwidth limitations and bottlenecks within one or more of these network segments triggers video and/or audio bit rate adjustments.

FIG. 8 is a block diagram of an exemplary implementation of gaming client 620 of FIG. 6. Gaming client 620 generally represents any type or form of computing device capable of reading computer-executable instructions. Gaming client 620 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 8, in addition to processor 622 and memory 624, gaming client 620 includes a communication infrastructure 802 and a communication interface 822 coupled to a network connection 824. Gaming client 620 also includes a graphics interface 826 coupled to a graphics device 828, an input interface 834 coupled to an input device 836, and a storage interface 838 coupled to a storage device 840.

Communication infrastructure 802 generally represents any type or form of infrastructure capable of facilitating communication between one or more components of a computing device. Examples of communication infrastructure 802 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 624 generally represents any type or form of volatile or non-volatile storage device or medium capable of storing data and/or other computer-readable instructions. In some examples, memory 624 stores and/or loads an operating system 808 for execution by processor 622. In one example, operating system 808 includes and/or represents software that manages computer hardware and software resources and/or provides common services to computer programs and/or applications on gaming client 620.

Operating system 808 performs various system management functions, such as managing hardware components (e.g., graphics interface 826, audio interface 830, input interface 834, and/or storage interface 838). Operating system 808 also provides process and memory management models for playback application 810. The modules of playback application 810 includes, for example, a content buffer 812, an audio decoder 818, and a video decoder 820.

Playback application 810 is configured to retrieve digital content via communication interface 822 and to play the digital content through graphics interface 826. Graphics interface 826 is configured to transmit a rendered video signal to graphics device 828. In normal operation, playback application 810 receives a request from a user to play a specific title or specific content. Playback application 810 then identifies one or more encoded video and audio streams associated with the requested title. After playback application 810 has located the encoded streams associated with the requested title, playback application 810 downloads sequence header indices associated with each encoded stream associated with the requested title from distribution infrastructure 610. A sequence header index associated with encoded content includes information related to the encoded sequence of data included in the encoded content.

In one embodiment, playback application 810 begins downloading the content associated with the requested title by downloading sequence data encoded to the lowest audio and/or video playback bitrates to minimize startup time for playback. The requested digital content file is then downloaded into content buffer 812, which is configured to serve as a first-in, first-out queue. In one embodiment, each unit of downloaded data includes a unit of video data or a unit of audio data. As units of video data associated with the requested digital content file are downloaded to the gaming client 620, the units of video data are pushed into the content buffer 812. Similarly, as units of audio data associated with the requested digital content file are downloaded to the gaming client 620, the units of audio data are pushed into the content buffer 812. In one embodiment, the units of video data are stored in video buffer 816 within content buffer 812 and the units of audio data are stored in audio buffer 814 of content buffer 812.

A video decoder 820 reads units of video data from video buffer 816 and outputs the units of video data in a sequence of video frames corresponding in duration to the fixed span of playback time. Reading a unit of video data from video buffer 816 effectively de-queues the unit of video data from video buffer 816. The sequence of video frames is then rendered by graphics interface 826 and transmitted to graphics device 828 to be displayed to a user.

An audio decoder 818 reads units of audio data from audio buffer 814 and output the units of audio data as a sequence of audio samples, generally synchronized in time with a sequence of decoded video frames. In one embodiment, the sequence of audio samples is transmitted to audio interface 830, which converts the sequence of audio samples into an electrical audio signal. The electrical audio signal is then transmitted to a speaker of audio device 832, which, in response, generates an acoustic output.

In situations where the bandwidth of distribution infrastructure 610 is limited and/or variable, playback application 810 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 826 is configured to generate frames of video data and transmit the frames of video data to graphics device 828. In one embodiment, graphics interface 826 is included as part of an integrated circuit, along with processor 622. Alternatively, graphics interface 826 is configured as a hardware accelerator that is distinct from (i.e., is not integrated within) a chipset that includes processor 622.

Graphics interface 826 generally represents any type or form of device configured to forward images for display on graphics device 828. For example, graphics device 828 is fabricated using liquid crystal display (LCD) technology, cathode-ray technology, and light-emitting diode (LED) display technology (either organic or inorganic). In some embodiments, graphics device 828 also includes a virtual reality display and/or an augmented reality display. Graphics device 828 includes any technically feasible means for generating an image for display. In other words, graphics device 828 generally represents any type or form of device capable of visually displaying information forwarded by graphics interface 826.

As illustrated in FIG. 8, gaming client 620 also includes at least one input device 836 coupled to communication infrastructure 802 via input interface 834. Input device 836 generally represents any type or form of computing device capable of providing input, either computer or human generated, to gaming client 620. Examples of input device 836 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Gaming client 620 also includes a storage device 840 coupled to communication infrastructure 802 via a storage interface 838. Storage device 840 generally represents any type or form of storage device or medium capable of storing data and/or other computer-readable instructions. For example, storage device 840 may be a magnetic disk drive, a solid-state drive, an optical disk drive, a flash drive, or the like. Storage interface 838 generally represents any type or form of interface or device for transferring data between storage device 840 and other components of gaming client 620.

Many other devices or subsystems are included in or connected to gaming client 620. Conversely, one or more of the components and devices illustrated in FIG. 8 need not be present to practice the embodiments described and/or illustrated herein. The devices and subsystems referenced above are also interconnected in different ways from that shown in FIG. 8. Gaming client 620 is also employed in any number of software, firmware, and/or hardware configurations. For example, one or more of the example embodiments disclosed herein are encoded as a computer program (also referred to as computer software, software applications, computer-readable instructions, or computer control logic) on a computer-readable medium. The term “computer-readable medium,” as used herein, refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, etc.), optical-storage media (e.g., Compact Disks (CDs), Digital Video Disks (DVDs), and BLU-RAY disks), electronic-storage media (e.g., solid-state drives and flash media), and other digital storage systems.

A computer-readable medium containing a computer program is loaded into gaming client 620. All or a portion of the computer program stored on the computer-readable medium is then stored in memory 624 and/or storage device 840. When executed by processor 622, a computer program loaded into memory 624 causes processor 622 to perform and/or be a means for performing the functions of one or more of the example embodiments described and/or illustrated herein. Additionally or alternatively, one or more of the example embodiments described and/or illustrated herein are implemented in firmware and/or hardware. For example, gaming client 620 is configured as an Application Specific Integrated Circuit (ASIC) adapted to implement one or more of the example embodiments disclosed herein

### Example Embodiments

Example 1: A computer-implemented method comprising: instantiating a memory management process that is configured to communicate with one or more graphics processing hardware components to control usage of shared memory by multiple different application instances, wherein the memory management process: receives a request from at least one the application instances indicating that content associated with a specific resource implemented by the application instance is to be stored in the shared memory, determines that the content identified in the request has been previously stored at a specified location in the shared memory, identifies a time span during which the identified content stored in the shared memory will be immutable, and instructs the requesting application instance to access the identified content from the specified location in shared memory during the identified time span.

Example 2: The computer-implemented method of Example 1, wherein the memory management process instructs the requesting application instance to access the identified content from the specified location in shared memory during the identified time span instead of storing the content associated with the specified resource in the memory.

Example 3: The computer-implemented method of Example 1 or Example 2, wherein the identified content stored in the shared memory is monitored by the memory management process.

Example 4: The computer-implemented method of any of Examples 1-3, wherein the memory management process is embedded in an application process package file associated with the application instance that sent the request.

Example 5: The computer-implemented method of any of Examples 1-4, wherein the memory management process determines whether the specific resource is already being managed by the memory management process using one or more resource identifiers or resource characteristics obtained from the application process package file.

Example 6: The computer-implemented method of any of Examples 1-5, wherein the application process package file comprises a game engine for a video game.

Example 7: The computer-implemented method of any of Examples 1-6, wherein the memory management process is dynamically loaded along with the application instance that sent the request.

Example 8: The computer-implemented method of any of Examples 1-7, wherein the memory management process is dynamically loaded using a Vulkan layer that allows dynamic interception of graphics application programming interface (API) calls.

Example 9: The computer-implemented method of any of Examples 1-8, wherein the memory management process determines whether the specific resource is already being managed by the memory management process using one or more resource identifiers or resource characteristics obtained from at least one intercepted API call.

Example 10: The computer-implemented method of any of Examples 1-9, wherein at least one of the resource identifiers obtained from the intercepted API call comprises a universally unique identifier (UUID).

Example 11: The computer-implemented method of any of Examples 1-10, wherein the intercepted API call increments a reference count and returns a shared file descriptor that points to a memory backing that was previously allocated for the resource.

Example 12: The computer-implemented method of any of Examples 1-11, wherein the application instance uses the shared file descriptor when accessing the specific resource.

Example 13: A system comprising: at least one physical processor, and physical memory comprising computer-executable instructions that, when executed by the physical processor, cause the physical processor to: instantiate a memory management process that is configured to communicate with one or more graphics processing hardware components to control usage of shared memory by multiple different application instances, wherein the memory management process: receives a request from at least one the application instances indicating that content associated with a specific resource implemented by the application instance is to be stored in the shared memory, determines that the content identified in the request has been previously stored at a specified location in the shared memory, identifies a time span during which the identified content stored in the shared memory will be immutable, and instructs the requesting application instance to access the identified content from the specified location in shared memory during the identified time span.

Example 14: The system of Example 13, wherein the memory management process preloads one or more resources for the application instance that sent the request.

Example 15: The system of Example 13 or Example 14, wherein the memory management process preserves the specified resource in the shared memory for at least a specified amount of time after determining that the specified resource is no longer being used by the multiple application instances.

Example 16: The system of any of Examples 13-15, wherein the specified resource is preserved in the shared memory for the specified amount of time based on a determined amount of churn that is related to the specified resource.

Example 17: The system of any of Examples 13-16, wherein content identified as being mutable is shared by the memory management process in a pool among the multiple different application instances.

Example 18: The system of any of Examples 13-17, wherein the content identified as being mutable is associated with a fence synchronization object that is used to track when asynchronous tasks performed using the content are completed.

Example 19: The system of any of Examples 13-18, wherein the memory management process redistributes the content identified as being mutable to the pool upon completion of the asynchronous tasks.

Example 20: A non-transitory computer-readable medium comprising one or more computer-executable instructions that, when executed by at least one processor of a computing device, cause the computing device to: instantiate a memory management process that is configured to communicate with one or more graphics processing hardware components to control usage of shared memory by multiple different application instances, wherein the memory management process: receives a request from at least one the application instances indicating that content associated with a specific resource implemented by the application instance is to be stored in the shared memory, determines that the content identified in the request has been previously stored at a specified location in the shared memory, identifies a time span during which the identified content stored in the shared memory will be immutable, and instructs the requesting application instance to access the identified content from the specified location in shared memory during the identified time span.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
instantiating a memory management process that is configured to communicate with one or more graphics processing hardware components to control usage of shared memory by multiple different application instances,
wherein the memory management process:
receives a request from at least one the application instances indicating that content associated with a specific resource implemented by the application instance is to be stored in the shared memory;
determines that the content identified in the request has been previously stored at a specified location in the shared memory;
identifies a time span during which the identified content stored in the shared memory will be immutable; and
instructs the requesting application instance to access the identified content from the specified location in shared memory during the identified time span.

2. The computer-implemented method of claim 1, wherein the memory management process instructs the requesting application instance to access the identified content from the specified location in shared memory during the identified time span instead of storing the content associated with the specified resource in the memory.

3. The computer-implemented method of claim 1, wherein the identified content stored in the shared memory is monitored by the memory management process.

4. The computer-implemented method of claim 1, wherein the memory management process is embedded in an application process package file associated with the application instance that sent the request.

5. The computer-implemented method of claim 4, wherein the memory management process determines whether the specific resource is already being managed by the memory management process using one or more resource identifiers or resource characteristics obtained from the application process package file.

6. The computer-implemented method of claim 4, wherein the application process package file comprises a game engine for a video game.

7. The computer-implemented method of claim 1, wherein the memory management process is dynamically loaded along with the application instance that sent the request.

8. The computer-implemented method of claim 7, wherein the memory management process is dynamically loaded using a Vulkan layer that allows dynamic interception of graphics application programming interface (API) calls.

9. The computer-implemented method of claim 8, wherein the memory management process determines whether the specific resource is already being managed by the memory management process using one or more resource identifiers or resource characteristics obtained from at least one intercepted API call.

10. The computer-implemented method of claim 9, wherein at least one of the resource identifiers obtained from the intercepted API call comprises a universally unique identifier (UUID).

11. The computer-implemented method of claim 9, wherein the intercepted API call increments a reference count and returns a shared file descriptor that points to a memory backing that was previously allocated for the resource.

12. The computer-implemented method of claim 11, wherein the application instance uses the shared file descriptor when accessing the specific resource.

13. A system comprising:
at least one physical processor; and
physical memory comprising computer-executable instructions that, when executed by the physical processor, cause the physical processor to:
instantiate a memory management process that is configured to communicate with one or more graphics processing hardware components to control usage of shared memory by multiple different application instances,
wherein the memory management process:
receives a request from at least one the application instances indicating that content associated with a specific resource implemented by the application instance is to be stored in the shared memory;
determines that the content identified in the request has been previously stored at a specified location in the shared memory;
identifies a time span during which the identified content stored in the shared memory will be immutable; and
instructs the requesting application instance to access the identified content from the specified location in shared memory during the identified time span.

14. The system of claim 13, wherein the memory management process preloads one or more resources for the application instance that sent the request.

15. The system of claim 13, wherein the memory management process preserves the specified resource in the shared memory for at least a specified amount of time after determining that the specified resource is no longer being used by the multiple application instances.

16. The system of claim 15, wherein the specified resource is preserved in the shared memory for the specified amount of time based on a determined amount of churn that is related to the specified resource.

17. The system of claim 13, wherein content identified as being mutable is shared by the memory management process in a pool among the multiple different application instances.

18. The system of claim 17, wherein the content identified as being mutable is associated with a fence synchronization object that is used to track when asynchronous tasks performed using the content are completed.

19. The system of claim 18, wherein the memory management process redistributes the content identified as being mutable to the pool upon completion of the asynchronous tasks.

20. A non-transitory computer-readable medium comprising one or more computer-executable instructions that, when executed by at least one processor of a computing device, cause the computing device to:
instantiate a memory management process that is configured to communicate with one or more graphics processing hardware components to control usage of shared memory by multiple different application instances,
wherein the memory management process:
receives a request from at least one the application instances indicating that content associated with a specific resource implemented by the application instance is to be stored in the shared memory;
determines that the content identified in the request has been previously stored at a specified location in the shared memory;
identifies a time span during which the identified content stored in the shared memory will be immutable; and
instructs the requesting application instance to access the identified content from the specified location in shared memory during the identified time span.
